(19) United States
(12) Patent Application Publication
(10) Pub. No.: US 2020/0110839 A1
(43) Pub. Date: Apr. 9, 2020

(54) DETERMINING TAGS TO RECOMMEND FOR A DOCUMENT FROM MULTIPLE DATABASE SOURCES

(71) Applicant: International Business Machines Corporation, Armonk, NY (US)

(72) Inventors: Fang Wang, Westford, MA (US); Su Liu, Austin, TX (US); Ivan M. Milman, Austin, TX (US); Charles D. Wolfson, Austin, TX (US); Charles K. Shank, Harvard, MA (US); Sushain Pandit, Austin, TX (US)

(21) Appl. No.: 16/153,535

(22) Filed: Oct. 5, 2018

(51) Int. Cl. G06F 17/30; G06F 17/27; G06N 5/00

(52) U.S. Cl. CPC G06F 17/30722; G06F 17/30011; G06N 5/00; G06F 17/2765; G06F 17/30699

(57) ABSTRACT

Provided are a computer program product, system, and method for determining tags to recommend for a document. A natural language processing module determines a document keyword for a document. A tag database search module determines, a tag in a tag database associated with the document keyword. A domain specific search module determines a domain specific tag in a domain specific knowledge base associated with the document keyword. A recommendation is made of at least one of the tag and the domain specific tag as a recommended tag for the document.

### BACKGROUND OF THE INVENTION

### 1. Field of the Invention

The present invention relates to a computer program product, system, and method for determining tags to recommend for a document from multiple database sources.

### 2. Description of the Related Art

To properly manage content and allow for searching of content in documents, a tag is associated with a document to provide metadata used to manage and search for the document. A tag is a non-hierarchical keyword or term assigned to a piece of information (such as an Internet bookmark, digital image, or computer file). Many applications allow the user to add tags or labels for the content, such as videos, documents, blogs, etc. There are also applications to classify web content more intelligently

There is a need in the art for improved techniques for assigning and generating document tags in a computer operating environment.

### SUMMARY

Provided are a computer program product, system, and method for determining tags to recommend for a document. A natural language processing module determines a document keyword for a document. A tag database search module determines, a tag in a tag database associated with the document keyword. A domain specific search module determines a domain specific tag in a domain specific knowledge base associated with the document keyword. A recommendation is made of at least one of the tag and the domain specific tag as a recommended tag for the document.

### BRIEF DESCRIPTION OF THE DRAWINGS

FIG. 1 illustrates an embodiment of a tagging system.

FIG. 2 illustrates an embodiment of a tag entry in a tag database.

FIG. 3 illustrates an embodiment of operations to process a document to tag.

FIG. 4 illustrates an embodiment of operations to process a user response to tag recommendations.

FIG. 5 illustrates an embodiment of operations to process a new user tag for a document.

FIG. 6 illustrates an embodiment of operations to process a user response to recommended modified user tags to substitute for a new user tag for a document.

FIG. 7 illustrates a computing environment in which the components of FIG. 1 may be implemented.

### DETAILED DESCRIPTION

A traditional hierarchical system taxonomy uses a top-down system having rigid pre-defined structures. However, in a tagging system, there is more than one way to classify an item, and one item can be assigned multiple tags. In common cases where users can freely add any tags, a number of issues arise, including: homonyms where the same tag/word has different meanings for different contexts, e.g., “apple” the fruit vs “Apple” the company; synonyms where different tags relate to the same concept; duplicates such as singular vs plural (e.g. “recipe” vs “recipes”), or in different languages such as “recipes” vs “ [symbol] ”; typos, such as “recipe” vs “recepe” or “recipee”, etc.; tag relationships, such as “recipe” vs “Texas recipes” vs “kids recipes”.

Described embodiments provide improved programming techniques for recommending tags for a document having a greater likelihood of being acceptable to the user providing the document to tag. Upon determining a document keyword based on content in the document, a tag database search module determines whether the document keyword is related to a tag in a tag database previously selected by the user for a related keyword in the tag database A domain specific search module processes a domain specific knowledge base, which may implement an ontology related to the document keyword, to determine a tag related to the document keyword. At least one tag determined from one of the tag database and the domain specific knowledge base is transmitted as at least one recommended tag to the user computer to select whether to use one of the at least one the recommended tag for the document.

The tag database and domain specific search module may comprise machine learning modules trained based on user acceptance or rejection of their tag recommendations to produce tag recommendations having a greater likelihood of acceptance by the user. For instance, the tag database and domain specific search modules may be trained to not output from their respective databases recommended tags for a document keyword the user does not accept to reduce the likelihood of outputting recommended tags unacceptable to the user. The search modules are further trained to output recommended tags the user accepts for a keyword to increase the likelihood of producing recommended tags that will be acceptable. In this way, the selections of recommended keywords by the search modules takes into account user subjective preferences as well as objective preferences based on the document keyword, user profile, etc.

Described embodiments provided improvements for selecting tags for a document by providing tag quality control, such as addressing typographical errors, singular versus plural, equivalents etc., recommending tags based on a user profile and the tagging logs, and combining both the automatic objective recommendations and subjective decisions from the user. Further, with described embodiments, the search modules have a self-learning capability to track user tagging habits for continuous improvement over time. Machine learning algorithms can be used to build relationships between document keywords, selected tags, and user preferences.

Described embodiments may further utilize with tagging services a natural language processing module that automatically extracts the keyword, content, and summary of a given unstructured document, a language translation module that can understand multiple languages to avoid duplicate tags, and consider a user profile and background, and additionally exploit web ontology databases as references for tag recommendations.

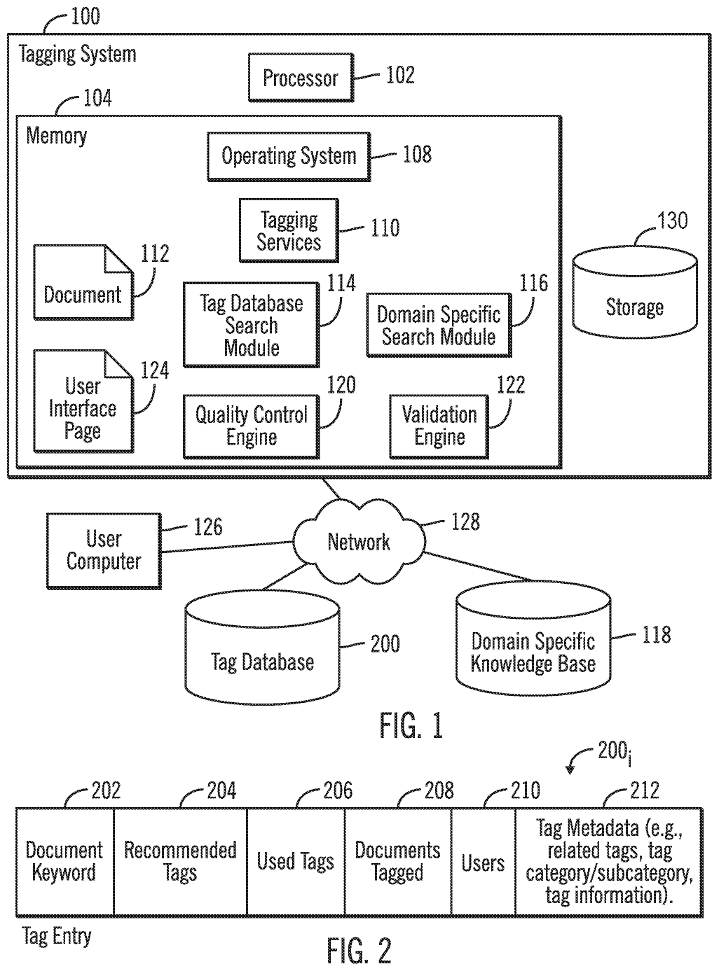

FIG. 1 illustrates an embodiment of a tagging system 100 in which embodiments are implemented. The tagging system 100 includes a processor 102 and a main memory 104. The main memory 104 includes various program components including an operating system 108, tagging services 110 to process a user document 112 to determine a tag for the document 112. The document may comprise a structured or unstructured document, comprise one or more of text, media, objects, etc. A tag comprises a keyword or term assigned to information that comprises metadata to describe an item and locate the item while searching. The tagging services 110 calls a tag database search module 114 to search a tag database 200 to determine tags to recommend related to document keywords determined from the document 112 and calls a domain specific search module 116 to determine tags to recommend related to document keywords as indicated in a domain specific knowledge base 118. The tag database 200 may maintain records of metadata with items including the documents, keywords, recommended tags, selected tags, the relationships etc. A graph database may represent the complicated relationships of the keywords and track documents under each tag entry to evaluate the effective usages of tags. The domain specific knowledge base 118 may comprise an ontology used to discover relationships of entities. For example, ontologies such as DBpedia or WordNet, comprise ontologies providing relationships of entities.

The memory 104 further includes a quality control engine 120 to process a user supplied tag for the document 112 to correct typographical errors, spelling, grammar, translation issues, etc., and a validation engine 122 to validate a user supplied tag, or new user tag, with respect to tags indicated in the tag database 200. The tagging services 110 may generate a user interface page 124, such as a Hypertext Markup Language (HTML) page, including recommended tags determined from searching the tag database 200 or the domain specific knowledge base 118 to return to a user computer 126 that provided the document 112 so that a user at the user computer 126 may select a recommended tag through the user interface page 124 or offer a new user supplied tag to use for the document 112.

The tagging system 100 may communicate with the tag database 200, the domain specific knowledge base 118, and the user computer 126 over a network 128. In an alternative embodiment, the tagging related program components in the tagging system 100 may be implemented in the user computer 126 to perform tagging operations locally.

In certain embodiments, the search modules 114 and 116 and the validation engine 122 may implement a machine learning algorithm technique such as decision tree learning, association rule learning, neural network, inductive programming logic, support vector machines, Bayesian network, etc., to search the database 200, 118 for recommended alternate tags, which learn how to search based on user acceptance or rejection of recommended tags to increase the likelihood that tag recommendations will be accepted by the user. In this way, the search modules 114, 116 are trained to recommend tags having a higher likelihood of acceptance by the user.

The tagging system 100 may store program components, such as 108, 110, 114, 116, 120, and 122, documents 112, tags applied to the documents, and user interface pages 124 in a non-volatile storage 130, which may comprise one or more storage devices known in the art, such as a solid state storage device (SSD) comprised of solid state electronics, NAND storage cells, EEPROM (Electrically Erasable Programmable Read-Only Memory), flash memory, flash disk, Random Access Memory (RAM) drive, storage-class memory (SCM), Phase Change Memory (PCM), resistive random access memory (RRAM), spin transfer torque memory (STM-RAM), conductive bridging RAM (CBRAM), magnetic hard disk drive, optical disk, tape, etc. The storage devices may further be configured into an array of devices, such as Just a Bunch of Disks (JBOD), Direct Access Storage Device (DASD), Redundant Array of Independent Disks (RAID) array, virtualization device, etc. Further, the storage devices may comprise heterogeneous storage devices from different vendors or from the same vendor.

The memory 104 may comprise a suitable volatile or non-volatile memory devices, including those described above.

Generally, program modules, such as the program components 108, 110, 114, 116, 120, and 122 may comprise routines, programs, objects, components, logic, data structures, and so on that perform particular tasks or implement particular abstract data types. The program components and hardware devices of the tagging system 100 of FIG. 1 may be implemented in one or more computer systems, where if they are implemented in multiple computer systems, then the computer systems may communicate over a network.

The program components 108, 110, 114, 116, 120, and 122 may be accessed by the processor 102 from the memory 104 to execute. Alternatively, some or all of the program components 108, 110, 114, 116, 120, and 122 may be implemented in separate hardware devices, such as Application Specific Integrated Circuit (ASIC) hardware devices.

The functions described as performed by the program 108, 110, 114, 116, 120, and 122 may be implemented as program code in fewer program modules than shown or implemented as program code throughout a greater number of program modules than shown.

The network 128 may comprise a Storage Area Network (SAN), Local Area Network (LAN), Intranet, the Internet, Wide Area Network (WAN), peer-to-peer network, wireless network, arbitrated loop network, etc.

FIG. 2 illustrates an embodiment of an instance of a tag entry 200ᵢ in the tag database 200 to provide information on considered and used tags, including a document keyword 202 determined from a document 112; recommended tags 204 comprising tags the tagging services 110 recommends in the user interface page 124 for the document keyword 22, as determined from the tag database 200 or domain specific knowledge base 118; used tags 206 comprising tags used for the document having the document keyword 202, which may comprise recommended tags 204 or user supplied tags; documents tagged 208 comprising the documents tagged with the used tags 206; and tag metadata 212, such as related tags, a tag category, sub-category, supra-category, etc.

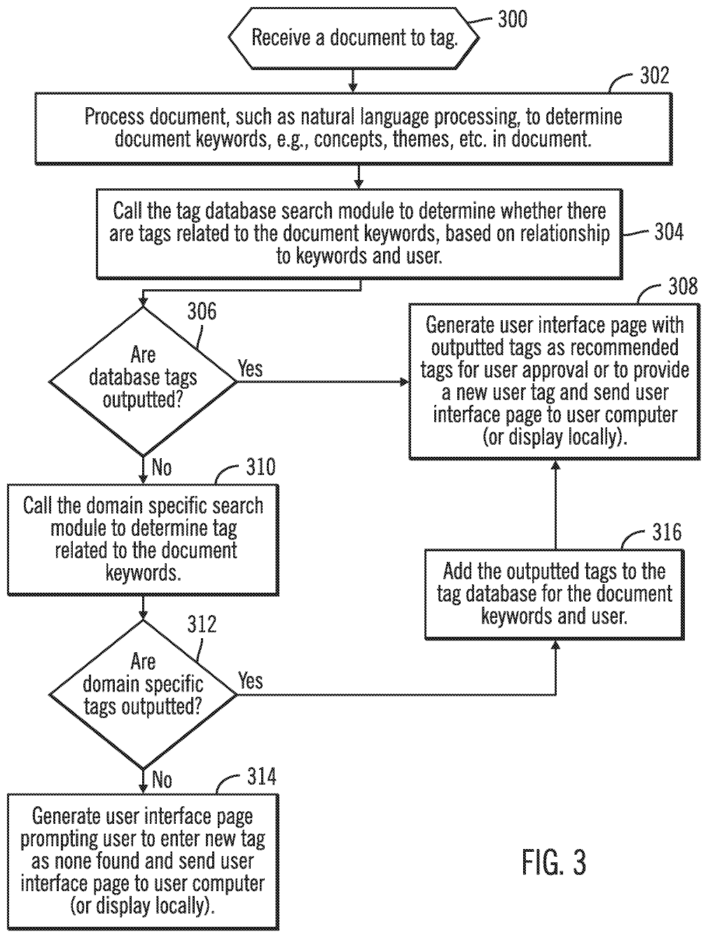

FIG. 3 illustrates an embodiment of operations performed by the tagging services 110 to recommend tags for a received document 112 to tag from a user computer 126. Upon receiving (at block 300) a document 112 to tag, the tagging services 110 processes (at block 302) the document 112, such as performing natural language processing (NLP), to determine document keywords, such as concepts, themes, high level tags, etc., in the document 112. In one embodiment, the tagging services 110 may use International Business Machines Corporation (IBM) Alchemy Concept Tagging, which returns concept tags based on content of the document. The tagging services 110 calls (at block 304) the tag database search module t114 o determine whether there are tags in the tag database 200 related to the document keywords, such as tags 204, 206 associated with a document keywords 202 in tag entries 200ᵢ related to the determined document keywords. Document keywords may be related to document keywords 202 in tag entries 200ᵢ based on relationships such as mapping, stemming, etc.

If (at block 306) the tag database search module 114 outputs determined tags, then the tagging services 110 generates (at block 308) a user interface page 124 with the outputted tags as recommended tags for user approval or to provide a new user tag, and sends the user interface page 124 to the user computer 126 (or display locally). If (at block 306) the tag database search module 114 does not output determined tags, then the tagging services 110 calls (at block 310) the domain specific search module 116 to determine tags related to the document keywords from the domain specific knowledge base 118. If (at block 312) the domain specific search module 116 outputs domain specific tags, then the outputted tags are added (at block 316) to the tag database 200 in tag entries 200ᵢ as recommended tags 204 for the document keywords 202, the user 210, and the document 208. Control proceeds to block 308 to generate a user interface page 124 with the determined domain specific tags as the recommended tags to send to the user computer 126 to accept or reject. If (at block 312) there are no domain specific tags outputted, then the tagging services 110 generates (at block 314) a user interface page 124 prompting a user at a user computer 126 to enter a new user tag and send the user interface page 124 to the user computer 126 (or display locally).

The search modules 114, 116, which may comprise machine learning modules, may receive input parameters to assist in searching for tags, including the document keywords, user profile information, document metadata, related entries or information in the databases 200, 118 to use to determine document keywords from the databases 200, 118.

With the embodiment of operations of FIG. 3, the tagging services 110 may obtain recommendations from a tag database 200 having information on tags used for document keywords for other documents from users and from a domain specific knowledge base that provides an ontology of related terms. This provides recommended tags from a wide range of sources for the user to consider to use for a document. Further, recommended tags from the domain specific knowledge base 118 may be added to the tag database 200 to be available for further recommendations and use from the tag database 200.

In the embodiment of FIG. 3, the domain specific knowledge base 118 is searched if the tag database 200 does not yield results. In an alternative embodiment, the tagging services 110 may invoke both search modules 114 and 116 to generate recommendations from both the tag database 200 and the domain specific knowledge base 118 to include in recommended tags to provide to the user in a user interface page 124.

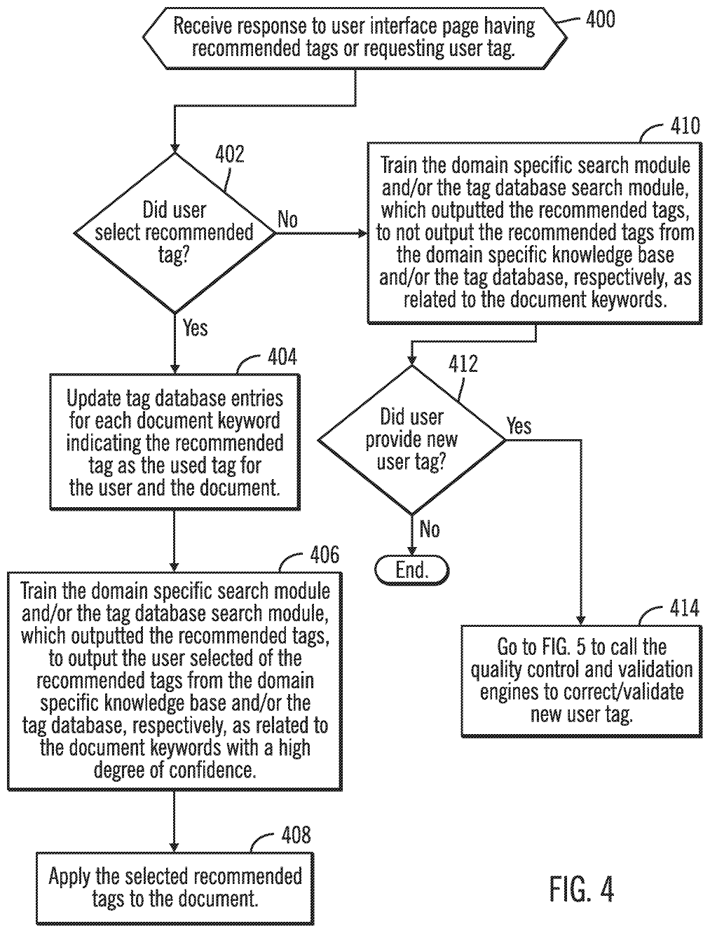

FIG. 4 illustrates an embodiment of operations performed by the tagging services 110 to process a user response to a user interface page 124, which may or may not include recommended tags. The user may accept one or more of the recommended tags to apply to a document or not accept any recommended tag. Upon receiving (at block 400) the user response, if (at block 402) the user selected one of the recommended tags, then the tag database 200 entries 200ᵢ are updated (at block 404) for each document keyword 202 indicating the selected recommended tag as a used tag 206, and all the recommended tags in the user interface page 124 are indicated as recommended tags 204 for the document keyword 202 for the user 210 and document 208. The tagging services 110, or other component, may then train (at block 406) the domain specific search module 116 and/or the tag database search module 114, which outputted the recommended tags, to output the user selected of the recommended tags from the domain specific knowledge base 118 and/or the tag database 200, respectively, as related to the document keywords, provided as input to train the modules 114, 116, with a high degree of confidence. The user selected recommended tag(s) are applied (at block 408) to the received document 112 to tag the document for various uses in the system.

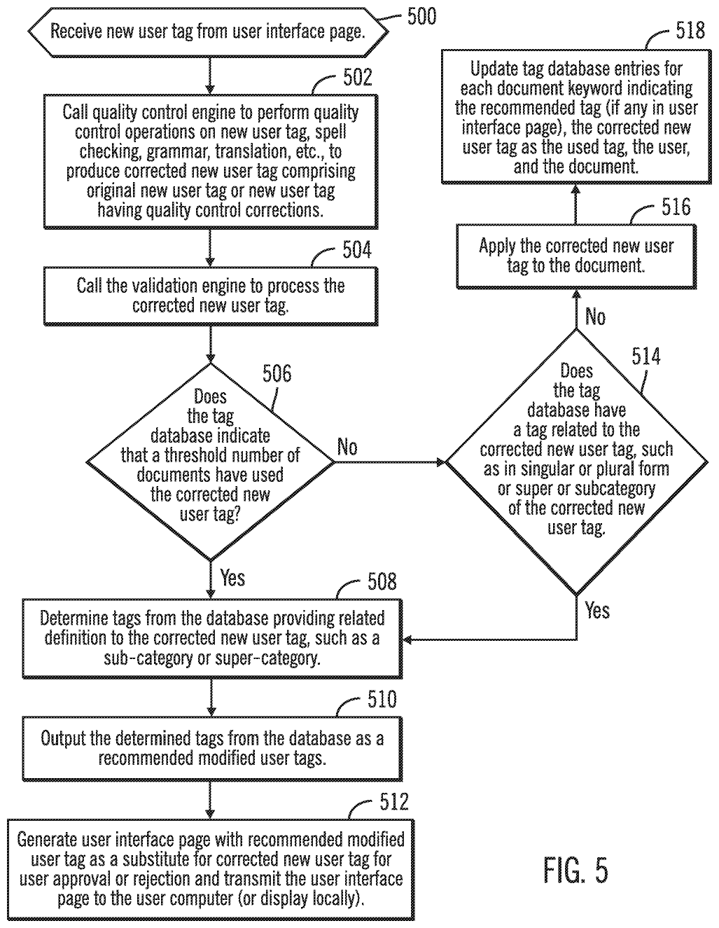

If (at block 402) the user did not select one of the recommended tags, as indicated in the user interface page 124, then the tagging services 110, or other component, trains (at block 410) the domain specific search module 116 and/or the tag database search module 114, which outputted the recommended tags, to not output the recommended tags from the domain specific knowledge base 118 and/or the tag database 200, respectively, as related to the determined document keywords, which are provided as input to train the modules 114/116. The inputs to train the module 114, 116 at blocks 406 and 410 may comprise the same inputs used to determine the recommended tags from the databases 118, 200, such as the document 112 keywords, user profile information, etc. If (at block 412) the user provided a new user tag for the document 112, then control proceeds to FIG. 5 to invoke the quality control 120 and validation engines 122 to correct and validate the new user tag to improve upon the user suggestions. If no recommended tag is selected and no new user tag provided, then (from the no branch of block 412) control ends without tagging the document 112.

With the embodiment of FIG. 4, the search modules 114, 116 are trained to improve the tag recommendations they provide to increase the likelihood the recommendations selected by the user will be accepted by increasing the confidence level of recommended tags determined by the search modules 114, 116 that are selected by the user. This further reduces the likelihood of recommending tags for document keywords the user rejects. By training the modules 114, 116 to output the user selection of recommended tags based on input of the keywords for a document 112 and other information to generate the recommended tags, the modules 114, 116 are improved to recommend tags having a higher likelihood of acceptance.

In certain embodiments, initially (during a training phase), the tagging services 110 may observe user feedback and uses that to prepare labelled examples. After a significant number of iterations, it the labelled data are used to train the search modules 114, 116. Subsequently, the tagging services 110 may enter a smart operation and continuous learning mode to determine whether to or not to suggest corrections to user created tags as part of the validation operations of the validation engine 122.

The search modules 114, 116 may be trained by modelling a relationship between potential classifications (recommended tags and tags not recommended) and a feature vector formed using a combination of tag metadata from the tag database 200 and optionally, a text feature extraction (TF-IDF) of associated document vectors from the document 112. By such training, the modules 114, 116 learn how to suggest existing tags that have a higher likelihood of acceptance by the user based on document keywords, such as text feature extraction, and other information.

FIG. 5 illustrates an embodiment of operations to process a new user tag supplied by the user in response to the user interface page 124 (generated at blocks 308 or 314 in FIG. 3) in which tags were recommended or not recommended. Upon receiving a new user tag in response to a user interface page 124 from a user computer 126, the tagging services 110 calls (at block 502) the quality control engine 120 to perform quality control operations on the new user tag for the document 112, such as spell checking using a dictionary, grammar, translation checking, etc., to produce a corrected new user tag comprising original new user tag or new user tag having quality control corrections. The validation engine 122 is called (at block 504) to process the corrected new user tag by performing the operations at blocks 506 through 514. The validation engine 122 determines (at block 506) whether the tag database 200 indicates that a threshold number of documents have used the corrected new user tag, such as by determining whether the corrected new user tag is indicated as a used tag 206 with a threshold number of documents 208 tagged with the used tag 206. If the corrected new user tag is used with documents the threshold number of times, then the validation engine 122 determines (at block 508) one or more tags tag from the database 200 providing related definition to the corrected new user tag, such as a sub-category, super-category, synonym, related meaning, etc. The determined one or more tags are outputted (at block 510) as a recommended modified user tag. The validation engine 122 or tagging services 110 may generate (at block 512) a user interface page 124 with the recommended modified user tags as a substitute for the corrected new user tag for user approval or rejection and transmit the user interface page 124 to the user computer 126 (or display locally).

If (at block 506) the tag database 200 does not indicate a threshold number of documents for the corrected new user tag, then the validation engine 122 determines (at block 514) whether the tag database 200 has a tag 204, 206 related to the corrected new user tag, such as in singular or plural form or super or sub-category of the corrected new user tag, etc. If (at block 514) the tag database has a form of the corrected new user tag, then control proceeds to block 508 to provide determined tags as recommended modified user tags to consider. If (at block 514) the tag database 200 does not have a recommended tag for the user to consider, then the corrected new user tag is applied (at block 516) to the document 112 and the tag database entries 200ᵢ for each document keyword are updated (at block 518) to indicate the recommended tag (if any in user interface page 124) as recommended tag 204, the corrected new user tag as the used tag 206, and the documents 112 tagged and the user in fields 208 and 210, respectively, for the document keyword 202 in the tag entry 200ᵢ being updated.

With the embodiment of FIG. 5, a user supplied tag is first corrected for typographical or other obvious type errors and then a validation engine 122 is operated to determine if the tag database 200 provides related tags to recommend to the user to consider to substitute for the user supplied tag that are consistent with tags already used in the database to provide a more uniform selection of tags for documents.

Further, the embodiment of FIG. 5 provides improvements to selecting a tag by limiting the user of a tag to a threshold number of documents, because if too many documents are labeled with the same tag, then content management and searching may be inefficient. Once the threshold number of uses of the tag with documents is reached, the document may be tagged with a related, but different, tag word to improve content management and searching for that document.

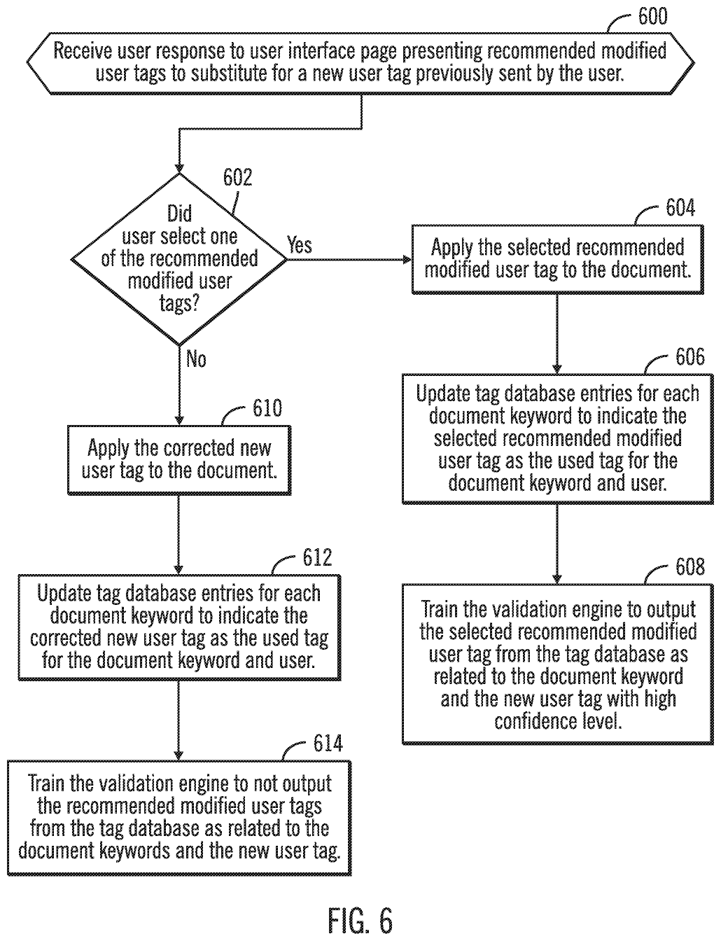

FIG. 6 illustrates an embodiment of operations performed by the tagging services 110 to process a user response to a user interface page 124 having recommended modified user tags, such as generated at block 512, sent in response to receiving a new user tag, which may be presented to use in lieu of a recommended tag. The user may select to accept multiple of the recommended tags or none of the recommended tags. Upon receiving (at block 600) a response to the recommended modified user tag to substitute for the new user tag, if (at block 602) the user selected the recommended modified user tag to use instead of the new user tag the user previously provided, then the recommended modified user tag is applied (at block 604) to the document 112. The tag database entries 200ᵢ for each document keyword used to determine the tag, are updated (at block 606) to indicate the selected recommended modified user tag as the used tag 206 for the document keyword 202 and user 210.

The tagging services 110, or other component, trains (at block 608) the validation engine 122 to output the selected recommended modified user tag from the tag database 220 as related to the document keywords and the new user tag with high confidence level to increase the likelihood the validation engine 122 outputs recommended modified user tags that have a higher likelihood of user acceptance. If (at block 602) the user did not select one of the recommended modified user tags, i.e., did not like the validation engine 122 suggestions, then the tagging services 110 updates (at block 612) the tag database entries 200ᵢ for each document keyword to indicate the corrected new user tag as the used tag 206 for the document keyword 202 and user 210. The validation engine 122 is trained (at block 614) to not output the recommended modified user tags from the tag database 200 as related to the document keywords and the new user tag to avoid further recommendations of tags the user did not previously accept.

With the embodiment of FIG. 6, the selection of a tag is further optimized by providing a recommendation for a new user tag to use that is consistent with tags used in the database 200ᵢ to increase the likelihood that a more consistent set of tags are used across documents. Depending on whether the user accepts this recommendation to substitute for their suggested tag, the validation engine 122 is trained based on the user suggestion to increase the likelihood that the tags recommended by the validation engine 122 for a user proposed new user tag will be accepted by the user, and not rejected, and thus not waste user time and increase the likelihood suggestions from the tag database will be used.

In further embodiments, a user may select recommended tags as well as suggest a new user tag when considering tags recommended provided at blocks 308, 314, and 512.

The described embodiments may further apply to a folksonomy, which comprises a system where multiple users apply public tags to online items, such as in collaborative tagging or social taggings, where the tags of other users to items are available for all to use. In such folksonomy environments, the tagging services 110 may look for used tags for keywords for the users participating in the folksonomy and train the machine learning modules 114, 116, and 122 to provide recommendations based on the preferences of all users in the folksonomy to reflect group preferences for tag recommendations for certain keywords.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

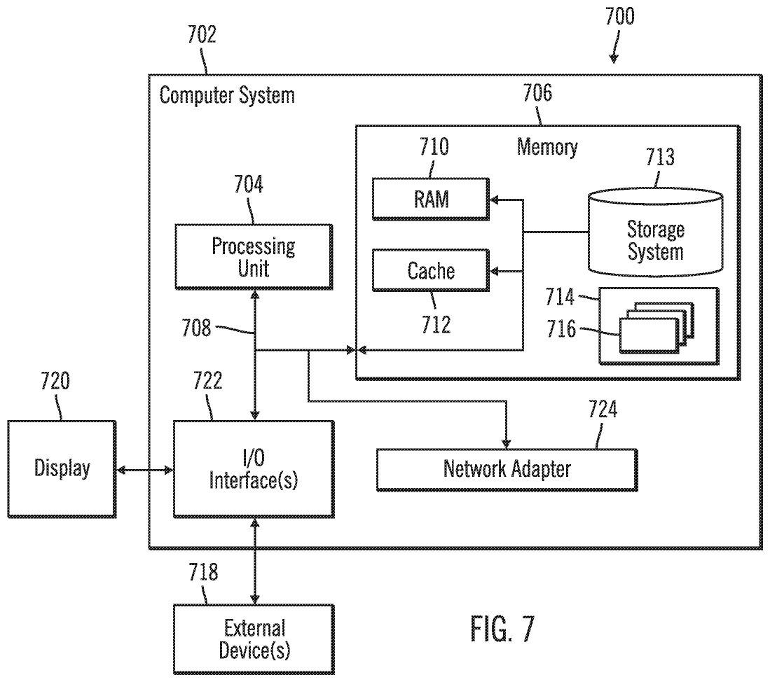

The computational components of FIG. 1, including the tagging system 100, may be implemented in one or more computer systems, such as the computer system 702 shown in FIG. 7. Computer system/server 702 may be described in the general context of computer system executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system/server 702 is shown in the form of a general-purpose computing device. The components of computer system/server 702 may include, but are not limited to, one or more processors or processing units 704, a system memory 706, and a bus 708 that couples various system components including system memory 706 to processor 704. Bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media.

System memory 706 can include computer system readable media in the form of volatile memory, such as random access memory (RAM) 710 and/or cache memory 712. Computer system/server 702 may further include other removable/non-removable, volatile/non-volatile computer system storage media. By way of example only, storage system 713 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 708 by one or more data media interfaces. As will be further depicted and described below, memory 706 may include at least one program product having a set (e.g., at least one) of program modules that are configured to carry out the functions of embodiments of the invention.

Program/utility 714, having a set (at least one) of program modules 716, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. The components of the computer 702 may be implemented as program modules 716 which generally carry out the functions and/or methodologies of embodiments of the invention as described herein. The systems of FIG. 1 may be implemented in one or more computer systems 702, where if they are implemented in multiple computer systems 702, then the computer systems may communicate over a network.

Computer system/server 702 may also communicate with one or more external devices 718 such as a keyboard, a pointing device, a display 720, etc.; one or more devices that enable a user to interact with computer system/server 702; and/or any devices (e.g., network card, modem, etc.) that enable computer system/server 702 to communicate with one or more other computing devices. Such communication can occur via Input/Output (I/O) interfaces 722. Still yet, computer system/server 702 can communicate with one or more networks such as a local area network (LAN), a general wide area network (WAN), and/or a public network (e.g., the Internet) via network adapter 724. As depicted, network adapter 724 communicates with the other components of computer system/server 702 via bus 708. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for determining a tag for a document, wherein the computer program product comprises a computer readable storage medium having program instructions embodied therewith that when executed cause operations, the operations comprising:
determining, by a natural language processing module, a document keyword for a document;
determining, by a tag database search module, a tag in a tag database associated with the document keyword;
determining, by a domain specific search module, a domain specific tag in a domain specific knowledge base associated with the document keyword; and
recommending at least one of the tag and the domain specific tag as a recommended tag for the document.

2. The computer program product of claim 1, wherein the determining by the domain specific search module is based on the determining by the tag database search module.

3. The computer program product of claim 2, wherein the operations further comprising:
adding the domain specific tag to the tag database.

4. The computer program product of claim 1, wherein the operations further comprising:
in response to the recommended tag not being accepted, training the tag database search module to decrease a likelihood of outputting the recommended tag from the tag database.

5. The computer program product of claim 1, wherein the operations further comprising:
in response to the recommended tag being accepted, training the tag database search module to increase a likelihood of outputting the recommended tag from the tag database.

6. The computer program product of claim 1, wherein the operations further comprising:
receiving a new tag for the document keyword in response to recommending the recommended tag for the document.

7. The computer program product of claim 6, wherein the operations further comprising:
determining a new recommended tag based on the new tag; and
recommending the new recommended tag for the document.

8. The computer program product of claim 7, wherein the operations further comprising:
updating the tag database to include the new tag and the new recommended tag.

9. The computer program product of claim 7, wherein the determining the new recommended tag comprises performing a quality control operation on the new tag.

10. The computer program product of claim 7, wherein the new recommended tag is related to the new tag.

11. The computer program product of claim 10, wherein the new recommended tag is one of a version of the new tag in a different grammatical form, a sub-category of the new tag in the tag database, and a super-category of the new tag in the tag database.

12. The computer program product of claim 8, wherein the new recommended tag is determined in response to a threshold number of documents associated with the new tag.

13. A system for determining a tag for a document, comprising:
a processor; and
a computer readable storage medium having program instructions embodied therewith that when executed by the processor cause operations, the operations comprising:
determining, by a natural language processing module, a document keyword for a document;
determining, by a tag database search module, a tag in a tag database associated with the document keyword;
determining, by a domain specific search module, a domain specific tag in a domain specific knowledge base associated with the document keyword; and
recommending at least one of the tag and the domain specific tag as a recommended tag for the document.

14. The system of claim 13, wherein the operations further comprising:
in response to the recommended tag not being accepted, training the tag database search module to decrease a likelihood of outputting the recommended tag from the tag database; and
in response to the recommended tag being accepted, training the tag database search module to increase a likelihood of outputting the recommended tag from the tag database.

15. The system of claim 13, wherein the operations further comprising:
receiving a new tag for the document keyword in response to recommending the recommended tag for the document.

16. The system of claim 15, wherein the operations further comprising:
determining a new recommended tag based on the new tag; and
recommending the new recommended tag for the document.

17. The system of claim 16, wherein the new recommended tag is determined in response to a threshold number of documents associated with the new tag.

18. A method for determining a tag for a document, comprising:
determining, by a natural language processing module, a document keyword for a document;
determining, by a tag database search module, a tag in a tag database associated with the document keyword;
determining, by a domain specific search module, a domain specific tag in a domain specific knowledge base associated with the document keyword; and
recommending at least one of the tag and the domain specific tag as a recommended tag for the document.

19. The method of claim 18, further comprising:
in response to the recommended tag not being accepted, training the tag database search module to decrease a likelihood of outputting the recommended tag from the tag database; and.
in response to the recommended tag being accepted, training the tag database search module to increase a likelihood of outputting the recommended tag from the tag database.

20. The method of claim 18, further comprising:
receiving a new tag for the document keyword in response to recommending the recommended tag for the document.

21. The method of claim 20, further comprising:
determining a new recommended tag based on the new tag; and
recommending the new recommended tag for the document.

22. The method of claim 21, wherein the new recommended tag is determined in response to a threshold number of documents associated with the new tag.
